(19) United States
(12) Patent Application Publication
(10) Pub. No.: US 2011/0113940 A1
(43) Pub. Date: May 19, 2011

(54) System for Recycling Used Tyres Comprising a High-Pressure Fluid Spray Head

(76) Inventor: Renato Florean, Amneville (FR)

(21) Appl. No.: 12/990,829

(22) PCT Filed: May 5, 2009
(86) PCT No.: PCT/EP09/55391

§ 371 Date: Jan. 20, 2011

(30) Foreign Application Priority Data
May 6, 2008 (FR) 0852989

(51) Int. Cl. B26F 3/00

(52) U.S. Cl. 83/53; 83/177

(57) ABSTRACT

A system for recycling used tires uses a high-pressure fluid spray head. The spray head comprises a body mounted rotatably about an axis of rotation generally perpendicular to a surface to be treated, and a plurality of outlet nozzles, each suitable for directing a jet of fluid at the surface to be treated. The plurality of outlet nozzles includes at least two outlet nozzles suitable for directing jets of fluid in at least two different directions.

### BACKGROUND

The invention relates to a system for recycling used tires comprising a high-pressure fluid spray head.

Such an installation makes it possible to separate the materials constituting a tire for the purpose of recycling or reusing at least some of the materials.

Such a system is described notably in document D1 (U.S. Pat. No. 5,341,996). It notably comprises a means for holding and rotating a tire, and a means for spraying jets of fluid onto the tire to be treated. The spraying means comprises several spray heads each comprising an axis of symmetry. The spraying means also comprises a means for orienting the axis of symmetry of the heads perpendicularly to the surface of the tire to be treated and for rotating the heads about their axis of symmetry. On the periphery of the heads, on one and the same radius, a plurality of outlet nozzles are positioned which direct jets of fluid under pressure in a direction perpendicular to the tire to be treated or at an angle in order to treat surfaces of the tire to be treated that do not pass directly beneath the spray heads.

Such a system makes it possible to separate the metal portions from the fabrics and rubbers of the user tires, but it is not very efficient. The particles of material torn away from the carcass of the tires are quite coarse and consequently quite difficult to recycle. Equally, many passes are often necessary to eliminate all the particles of fabrics and rubber.

### SUMMARY OF THE INVENTION

One object of the invention is to propose a shredding system that is more efficient than the known systems.

For this reason, the invention proposes a system for recycling used tires comprising at least one head for spraying a fluid at high pressure onto a surface to be treated. The spray head comprises a body mounted so as to rotate about an axis of rotation that is substantially perpendicular to the surface to be treated, and a plurality of outlet nozzles each appropriate for directing a jet of fluid toward the surface to be treated.

According to the invention, the system is characterized in that the plurality of outlet nozzles comprises at least two outlet nozzles that are appropriate for orienting respective jets of fluid in at least two directions having different angles relative to the axis of rotation. In other words, according to the invention, the angles between the directions of the jets and the axis of rotation of the spray head are different so that the jets attack the surface to be treated at different angles of attack and that the trajectories of the jets intersect several times when the head is rotated and/or when the surface to be treated moves in front of the spray head. The result of this is a more rapid cutting of the fabrics surrounding the metal carcass of the treated tire. Equally, smaller residual particles are obtained after cutting which are therefore more easily usable or recyclable. Finally, after complete treatment of the tire, the metal carcass is cleaner.

Angles between the directions of the jets and the axis of rotation of the spray head of between −35° and +35° already give good results. Tests show that the range −25° to −5° or 5° to 25° makes it possible to obtain optimum results.

When the spray head is rotated, each jet attacks the surface to be treated in a ring centered on the axis of rotation of the spray head irrespective of the angle of attack of the jet. In order to have the largest possible surface area attacked for a more rapid treatment, the angles between the directions of the jets of fluid and the axis of rotation of the spray head may be chosen such that the zones of impact of the jets of fluid on the surface to be treated when the spray head is rotated form substantially adjacent or slightly overlapping rings.

According to a variant, the outlet nozzles of the plurality of outlet nozzles are situated on at least two radii that are substantially different from the axis of rotation of the spray head. Therefore, increasing the number of angles of attack and increasing the number of radii produces a larger number of different trajectories which further improves the effectiveness of the spray head.

The fluid used may be water under high pressure which has the advantage of being cheap and easily recyclable after cutting of the tires, compared with other fluids such as oil. Equally, water laden with abrasive particles makes it possible to use lower pressures.

A further subject of the invention is a method for recycling used tires according to which a tire is shredded by spraying a high-pressure fluid through a plurality of jets of fluid in the direction of a surface of the tire to be treated, the jets being able to rotate about an axis of rotation substantially perpendicular to a surface to be treated. The method is characterized in that the jets of fluid are oriented in at least two directions having different angles relative to the axis of rotation.

### BRIEF DESCRIPTION OF THE DRAWINGS

The invention will be better understood and other features and advantages will appear on reading the following description of an exemplary embodiment of a spray head according to the invention. The description should be read with reference to the appended drawings in which:

FIG. 1 is a schematic view of a system according to the invention;

FIG. 2 is a top view of a first embodiment of a spray head of the system of FIG. 1;

FIGS. 3 and 4 are respectively a top view and a side view of a second embodiment of a spray head according to the invention,

FIG. 5 is a diagram showing the trajectories of impact of the jets of fluid emitted by a spray head according to the invention;

FIG. 6 is a view in section of a tire showing the trajectories of the jets.

### DETAILED DESCRIPTION OF THE PREFERRED EMBODIMENT(S)

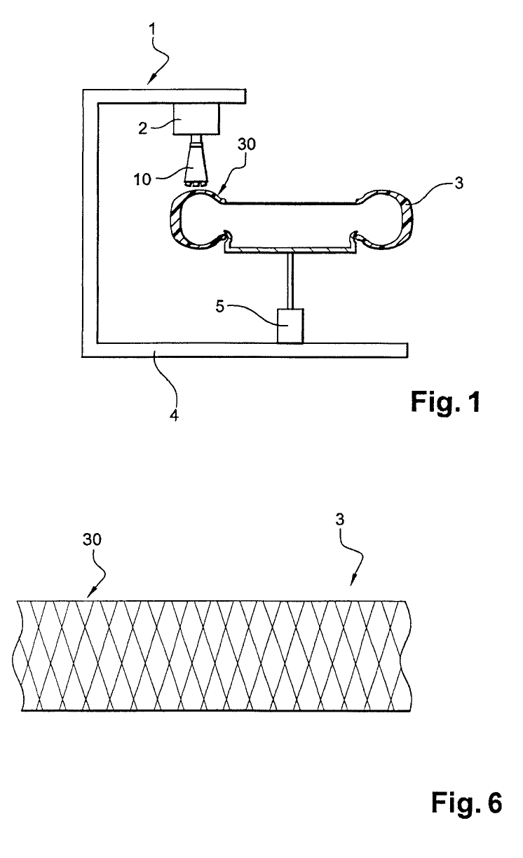

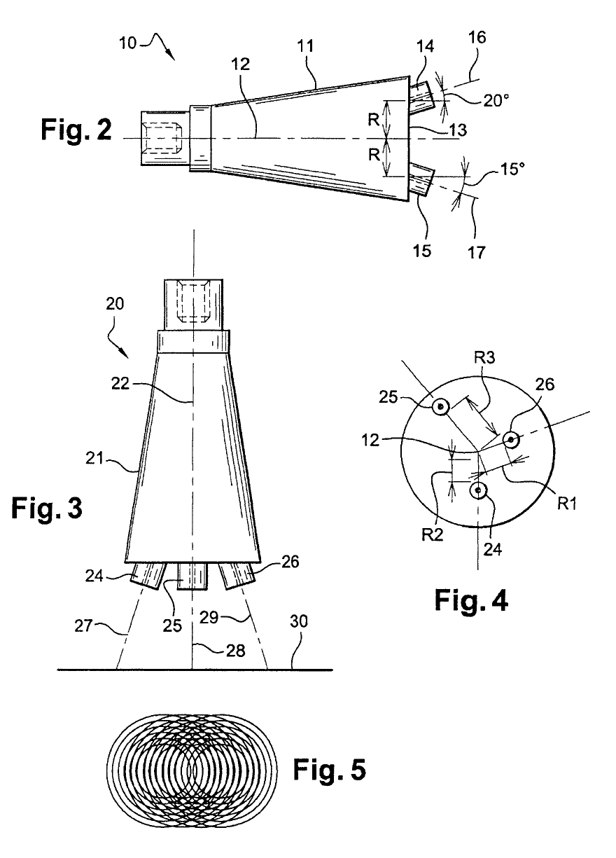

A system 1 for recycling tires according to the invention, as shown in FIG. 1, comprises a frame 4 on which means 5 for rotating a tire 3 make it possible to grip and rotate the tire about its axis. The system also comprises means for supporting a spray head making it possible to move and rotate the spray head 10 facing a surface to be treated 30 of the tire 3. The supporting means also make it possible to supply the spray head with fluid at very high pressure, for example between 2000 and 4000 bar.

In the example of FIG. 2, the spray head comprises a body that is of substantially conical shape and that has a main axis of symmetry 12. In operation in a system for recycling tires, the spray head is rotated about the axis of symmetry 12. The body 11 is closed by a bottom 13 to which are attached two fluid-outlet nozzles 14, 15 of substantially cylindrical shape. In this example, the two nozzles are positioned on one and the same radius of the bottom 13. In other words, the axes of symmetry 16, 17 of the nozzles both intersect the bottom 13 at a distance R from the main axis 12. Equally, the axes of symmetry 16, 17 correspond to the direction of the jets of fluid emitted by the outlet nozzles. In this example also, the axis of symmetry 16 of one of the nozzles forms an angle of 15° with the axis of symmetry 12 of the body 11, and the axis of symmetry 17 of the other nozzle forms an angle of 20° with the axis of symmetry 12 of the body 11.

It should be noted that the shape of the body of the spray head is immaterial. The shape of the outlet nozzles is also immaterial, the important aspect being only the direction of the jets coming out of said outlet nozzles.

In the example of FIG. 2, the spray head 20 also comprises a body 21 of substantially conical shape having a main axis of symmetry 22 and a bottom 23. In this example, three outlet nozzles 24, 25, 26 are attached to the bottom on three different radii R1, R2, R3 relative to the main axis of symmetry 22. The outlet direction of the jet 27 forms an angle of 5°, the outlet direction of the jet 28 forms an angle of 10° and the outlet direction of the jet 29 forms an angle of 15°. The angles between the radii R1, R2, R3 are identical in this instance in order to limit the resultant twisting forces when the spray head rotates.

The impact of each jet on the surface to be treated has a substantially circular shape if the direction of the jet is substantially perpendicular to the surface to be treated, or substantially elliptical if the direction of the jet is not perpendicular to the surface to be treated.

When the spray head is rotated on the axis of symmetry 22, the impact of each jet of fluid on the surface to be treated has substantially the shape of a ring. When the surface to be treated travels in front of the spray head (when the tire 3 to be recycled is rotated), the impact ring moves along the surface to be treated. FIG. 6 shows the trajectory of the two jets in the thickness of the tire. A first series of lines inclined in a first direction relative to the perpendicular to the surface to be treated 30 corresponds to the trajectories of the jets at the front of the movement, while a second series of lines inclined in a second direction opposite to the first direction corresponds to the trajectories of the jets at the rear of the movement. Multiple intersections are noted ensuring fine cutting of the particles of the tire 3.

In the example of FIG. 2, the angles between the directions 27, 28, 29 of the jets and the axis of rotation of the spray head are such that the impact rings of the jets to be treated are adjacent and are slightly superposed so that together the impacts of all the jets form a ring of great size (the size of the ring is the difference between the outer radius and the inner radius of the ring). Therefore, the zone of the surface to be treated that is impacted simultaneously by the jets produced by the spray head is considerable. This is shown in FIG. 5.

1-6. (canceled)

7. A system for recycling used tires comprising at least one high-pressure fluid spray head comprising a body mounted so as to rotate about an axis of rotation) substantially perpendicular to a surface to be treated, a plurality of outlet nozzles, each said nozzle being appropriate for directing a jet of fluid toward the surface to be treated, and the plurality of outlet nozzles comprising at least two outlet nozzles that are appropriate for orienting jets of fluid in at least two directions having different angles relative to the axis of rotation.

8. The system as claimed in claim 7, wherein the angles between the directions of the jets and the axis of rotation of the spray head are between −35° and +35°.

9. The system as claimed in claim 7, wherein the angles between the directions of the jets of fluid and the axis of rotation of the spray head are between −25° and −5°.

10. The system as claimed in claim 7, wherein the angles between the directions of the jets of fluid and the axis of rotation of the spray head are between 5° and 25°.

11. The system as claimed in claim 7, wherein the angles between the directions of the jets of fluid and the axis of rotation of the spray head are chosen such that the zones of impact of the jets of fluid on the surface to be treated when the spray head is rotated form one of substantially adjacent rings and or slightly overlapping rings.

12. The system as claimed in claim 7, wherein the outlet nozzles of the plurality of nozzles are situated on at least two radii that are substantially different from the axis of rotation of the spray head.

13. A method for recycling used tires comprising shredding a tire by spraying a high-pressure fluid through a plurality of jets of fluid in a direction of a surface of the tire to be treated, rotating the jets of fluid about an axis of rotation substantially perpendicular to the surface to be treated, and orienting the jets of fluid in at least two directions having different angles relative to the axis of rotation.
